(19) United States
(12) Patent Application Publication
(10) Pub. No.: US 2022/0242234 A1
(43) Pub. Date: Aug. 4, 2022

(54) SYSTEM INTEGRATING AUTONOMOUS DRIVING INFORMATION INTO HEAD UP DISPLAY

(71) Applicant: Stephen Favis, Sacramento, CA (US)

(72) Inventor: Stephen Favis, Sacramento, CA (US)

(21) Appl. No.: 17/519,132

(22) Filed: Nov. 4, 2021

Related U.S. Application Data
(60) Provisional application No. 63/077,384, filed on Sep. 11, 2020.

(51) Int. Cl. B60K 35/00; G06K 9/00; G02B 27/01

(52) U.S. Cl. CPC B60K 35/00; G06K 9/00791; G02B 27/0101; B60K 2370/1529; B60K 2370/175; G02B 2027/0141; B60K 2370/785; B60K 2370/166; B60K 2370/21; G06K 2209/23; B60K 2370/177

(57) ABSTRACT

An augmented reality head up display system in a vehicle with autonomous driving information uses information from Autonomous Driving cameras and sensors may be shown on the display in real-time. Auxiliary information including vehicle speed, distance to objects, roadway lanes, maps and map directions/routes, and potential vehicle collisions, and recommend vehicle positioning may be displayed. Some embodiments simulate future vehicle environments and courses to determine an optimal vehicle position and automatic movement if necessary.

### CROSS-REFERENCE TO RELATED APPLICATION

This application claims benefit under 35 U.S.C. § 119(e) of U.S. Provisional Application having Ser. No. 63/077,384 filed Sep. 11, 2020, which is hereby incorporated by reference herein in its entirety.

### FIELD

The subject disclosure relates to display systems and more particularly to a system integrating autonomous driving information into a head up display.

### BACKGROUND

Drivers use many technologies to aid in the driving experience.

Current methodologies for autonomous driving (AD) check the road, then check if there's an issue. Some may provide warnings of an imminent or potential collision but this is not helpful in complex driving situations. The computer vision in AD is not trained to recognize some hazards and traffic signs.

Some drivers use GPS to help them navigate their trip. GPS is hard to look at on a phone display or standalone device screen and takes the driver's focus away from the road. In addition, scale is not intuitive on GPS maps on devices and it is hard to tell if something is 5 miles away or 500 ft away.

As can be seen, there is a need to improve on driver assist technologies.

### SUMMARY

In one aspect of the disclosure, a vehicle driving assist system is disclosed. The system includes a head-up display (HUD). An augmented reality (AR) engine is connected to the HUD. Sensors positioned on the vehicle detect an environment surrounding the vehicle. A processor is connected to the sensors and to the AR engine. Environmental data detected by the sensors is provided to the processor. The processor is configured to determine a presence of physical objects and a position of respective physical objects relative to the vehicle based on the environmental data. The AR engine displays on the HUD an augmented reality scene that includes one or more virtual objects associated with one of the physical objects.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a partial perspective rear view of a vehicle cabin interior with a head-up display system in accordance with an aspect of the subject technology.

FIG. 2 is a perspective driver's side view of the cabin and system of FIG. 1.

FIG. 3 is a perspective rear passenger side view of the system of FIG. 1 with cabin elements omitted.

FIG. 4 is a perspective front passenger side view of the system of FIG. 3.

FIG. 5 is a rear view of the cabin of FIG. 1 with the head up display system omitted.

FIG. 6 is a diagrammatic view of simulated probability scenarios and determination of optimal driving maneuver according to another embodiment of the subject technology.

FIGS. 7A and 7B are a flowchart of a process for displaying autonomous driving information and recommendations on a head up display according to another embodiment of the subject technology.

FIG. 8 is an enlarged view of a digital map for display on a head up display system according to embodiments.

FIG. 9 is a front view of an augmented reality display system with a map overlay feature according to an embodiment.

FIG. 10 is a front view of an augmented reality display system with vehicle behavior indicators according to an embodiment.

FIG. 11 is an enlarged view of a vehicle displayed with a behavior indicator from FIG. 10 according to an embodiment.

FIG. 12 is an enlarged view of another vehicle displayed with a behavior indicator from FIG. 10 according to an embodiment.

FIG. 13 is an enlarged view of another vehicle displayed with a behavior indicator from FIG. 10 according to an embodiment.

FIG. 14 is a block diagram of a control system according to an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

Referring to the Figures in general, embodiments of the subject technology provide a head up display (“HUD”) system in a vehicle with autonomous driving information used and shown on the display in real-time. Information from sensors built into the vehicle are used for visual enhancement of the driving experience through the head-up display. In addition, some embodiments include an Autonomous Driving (“AD”) system for controlling the course of the vehicle automatically based on the information from the sensors. AD based information may be displayed in the HUD and presented in various forms including for example, a replica of the surrounding vehicle's driving environment (for example, simulated roads, vehicles, obstacles, and other road related elements). Auxiliary information including vehicle speed, distance to objects, roadway lanes, maps and map directions/routes, and potential vehicle collisions, and recommended vehicle positioning may be displayed.

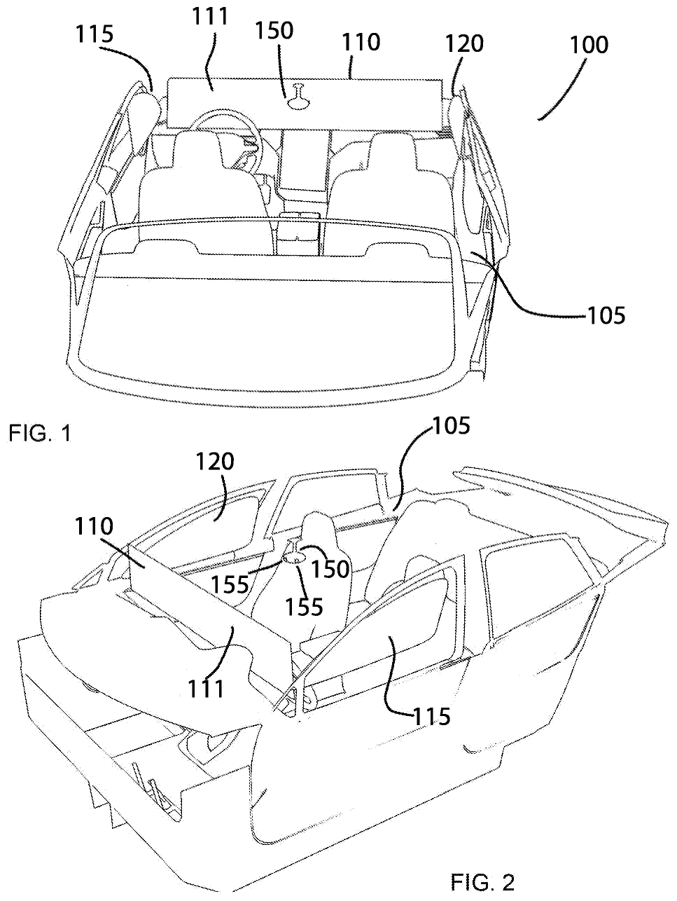

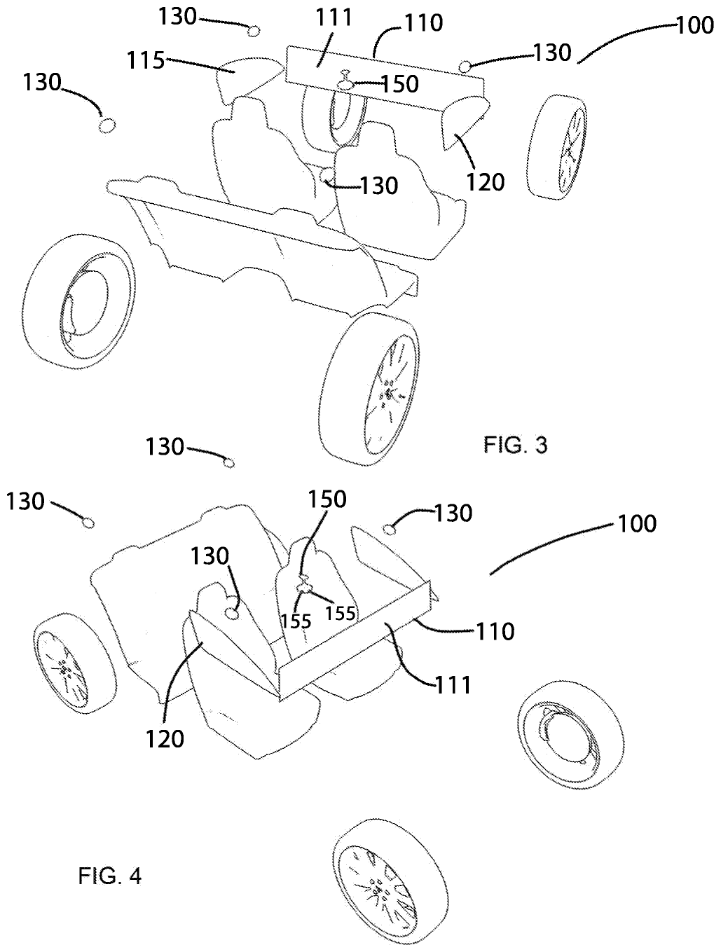

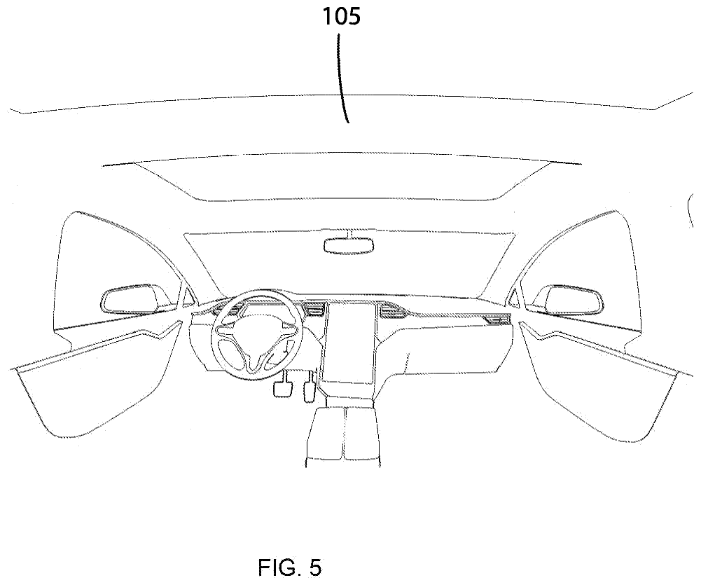

Referring now to FIGS. 1-4, a vehicle driving assist system 100 (sometimes referred to simply as the “system 100”) for a vehicle is shown according to embodiments. It will be understood that FIGS. 1-4 do not show a complete vehicle for sake of illustration. FIGS. 1 and 2 show a vehicle cabin interior 105. The cabin interior 105 is not necessarily part of the system 100. FIGS. 3 and 4 show seating elements of a vehicle without the surrounding chassis to illustrate relative positioning of some elements in the system 100 according to some embodiments. FIG. 5, which shows a typical vehicle cabin, is provided as a reference point to show elements commonly found in a vehicle, which in some embodiments may be retrofit with the system 100 to provide an assisted driving experience.

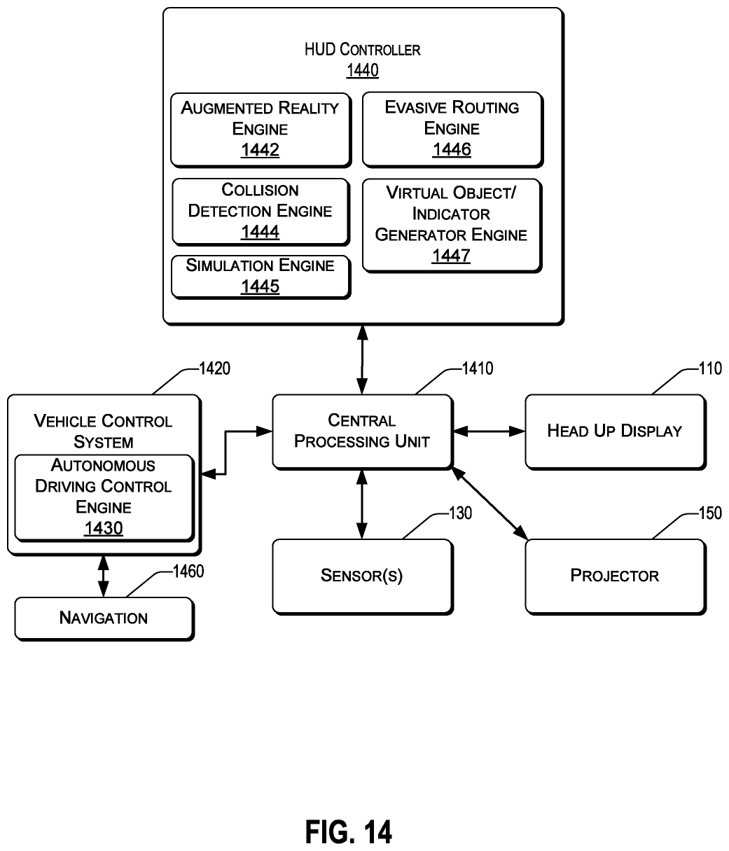

Referring back to FIGS. 1-4 and also to FIG. 14, embodiments generally include a head-up display 110. In some embodiments, the HUD 110 may display an AR scene over the real-world view seen through the windshield. For example, virtual objects representing physical objects or auxiliary information may be seen over or in addition to the physical objects viewable through the windshield. In some embodiments, the HUD 110 may display a simulation of the physical world outside the vehicle. As may be appreciated, a simulated scene of the environment may be useful to aid the driver when the visibility conditions under normal human vision are impaired.

The environmental information of the current environment surrounding the vehicle may be obtained from sensors 130 positioned on various parts of the vehicle. Embodiments may position a plurality of sensors 130 so that multiple or as many directions as possible detect environmental data that may be replicated onto the HUD 110. The sensors 130 may be for example, cameras, forward looking infrared (FLIR) sensors, thermal detectors, or ultrasonic detectors. The sensors 130 may detect physical objects near the vehicle, approaching the vehicle, or far off from the vehicle. Physical objects may include for example, other vehicles, lane markers, road boundaries such as guardrails, K-rails, impact devices, terrain, poles, signs, lane dividers, and debris. Physical objects may be moving or still.

The HUD 110 may be a standalone electronic display positioned in front of or on top of a windshield (not shown). In some embodiments, the HUD 110 includes a layer of fluorinated ethylene propylene (FEP) that may be installed onto a substrate as a standalone display structure or may be applied to a windshield/window structure as a film. In some embodiments, the HUD 110 may be integrated into the windshield. Integrated embodiments include wiring of glass that produces an electronic image. In some embodiments, the HUD 110 may comprise more than one section of a display. For example, the HUD 110 may include a front or central display area/section 111. The HUD 110 may include a driver side window display area/section 115. The HUD 110 may include a passenger side window display area/section 120. The front or central display area/section 111 may span a substantial length of the windshield or may span from approximately a left end of the dashboard (not shown) to approximately a center line of the vehicle. The driver side window display area/section 115 and the passenger side window display area/section 120 may cover a substantial portion of their respective side windows, (for example more than 50% of the window).

In some embodiments, the HUD 110 may be projected onto an existing surface including for example, the windshield or the layer of FEP. The system 100 may include a projector 150. The projector 150 may be positioned in the cabin interior 105 and disposed to project AR imagery or a virtual simulated environment onto the HUD 110. In some embodiments, the projector 150 may be a triple projector with multiple sub-projectors 155 disposed to project onto the front or central display area/section 111, the driver side window display area/section 115, and the passenger side window display area/section 120. Some embodiments include a selectable feature that displays an AR scene onto the display area/section of the user's choice.

Elements that may not be visible in FIGS. 1-4 are shown in FIG. 14 according to some embodiments. Elements not visible in FIGS. 1-4 may be hidden by other vehicle structures and may be generally electrical and software control elements. For example, the system 100 may include a central processing unit (CPU) 1410 coordinating information and functions between various elements. The system 100 may include a HUD controller module 1440 connected to the CPU 1410. The HUD controller 1440 may include modules that are configured to provide functionality and features that may be seen in the HUD 110 or experienced by the vehicle during the vehicle's operation. For example, embodiments may include an AR engine 1442 that processes the environmental data received from the sensors 130 and generates an AR scene in the HUD 110 based on the sensor data and software programming stored in the AR engine 1440. Some of the objects in the AR scene generated by the AR engine 1440 may be generated by a virtual object/indicator generator engine 1447. Some embodiments may include a simulation engine 1445 that may analyze statistical probabilities of road conditions and other traffic situations based on the sensor data to simulate scenarios involving the vehicle. Some of the data may be used in generating the AR scene and some of the data may be used in collision detection, collision avoidance, and automatic evasive maneuvering as described in more detail below. Some embodiments may include a collision detection engine 1444 that may predict collisions based on the simulation data. Imminent or potential collisions may generate an alert and/or display the path of the collision on the HUD 110 in the AR scene. Some embodiments may display one or more alternate courses for the vehicle to avoid the collision.

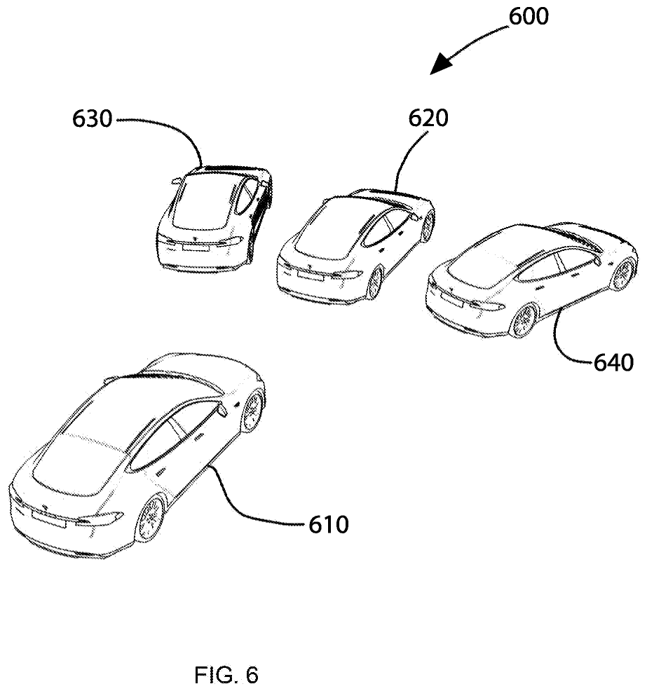

In an exemplary embodiment, the simulation engine 1445 is used at an accelerated pace to analyze statistical probability of road conditions and other traffic. The simulated scenarios may be used by the AD system to determine whether a collision may be imminent and whether the AD system should automatically engage vehicular deviation from the current trajectory into an optimal position which avoids collision and/or presents a better path for continuous driving. FIG. 6 shows different potential vehicle position changes based on a simulation.

In FIG. 6, an example AR scene 600 is shown with different simulated scenario positions displayed. The AR scene 600 shows the current position (610) of the vehicle as a virtual representation. The vehicle icon 620 may represent the vehicle's path without deviation, which in some scenarios may be on a collision course with an object (not shown). Some embodiments may include an evasive routing engine 1446 that may determine alternate courses for the path of the vehicle to avoid collisions. The alternate paths may be displayed in the HUD 110, for example, as the alternate courses that lead to vehicle positions 630 and 640. In some embodiments, the vehicle positions 630 and 640 may instead represent potential vehicle position changes based on a simulation

In some embodiments, the system 100 may include a vehicle control system 1420 that includes an autonomous driving control engine 1430. In AD embodiments, the vehicle control system 1420 may automatically control the course and speed of the vehicle using. The autonomous driving control engine 1430 may direct vehicle control based on data from an on-board navigation system 1460 and the data from the sensors 130, collision detection engine 1444, and simulation engine 1445. The autonomous vehicle control system 1420 may automatically take control of the vehicle (if the vehicle was not already being driven autonomously), in the event of an imminent or potential collision and steer the vehicle onto a safer alternate course. In some embodiments, the control of the vehicle is engaged for an optimized vehicle position (for example, increased distance from a vehicle ahead of the subject vehicle, a different lane with better traffic flow up ahead, easier lane changing position for an upcoming lane change or merge, etc.). In some embodiments, the alternate course is shown in the HUD 110.

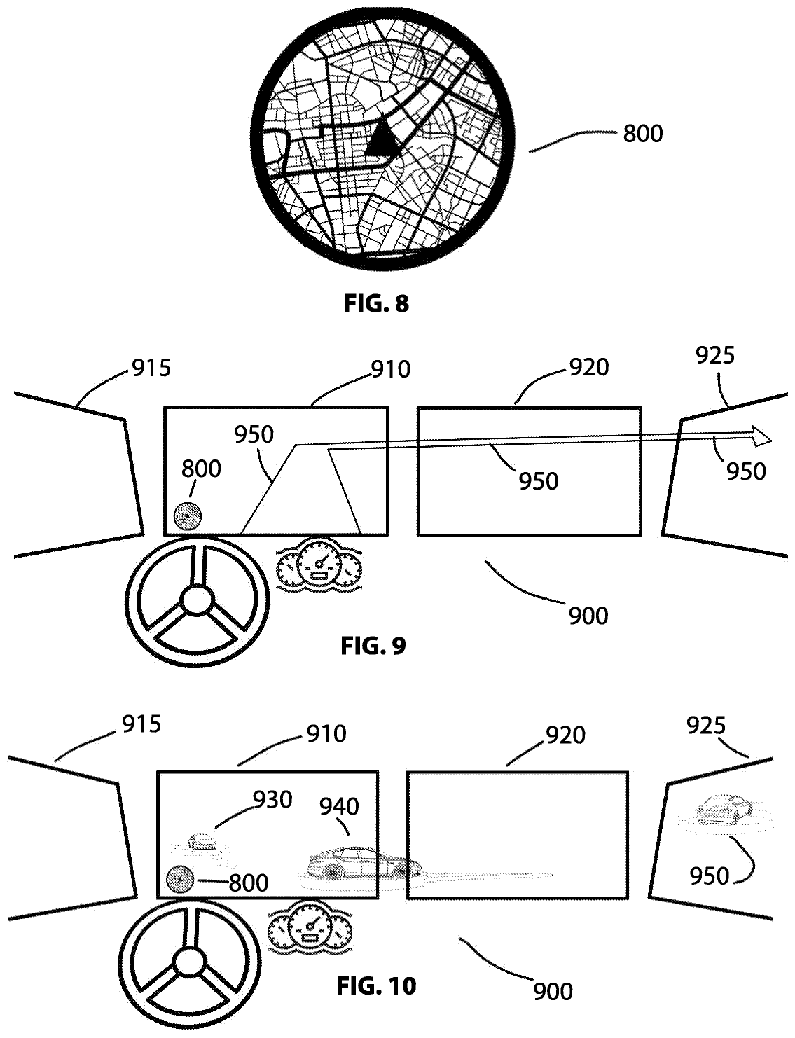

In some embodiments, the on-board navigation system 1460 may generate a digital map in the HUD 110. FIG. 8 shows a digital map 800 that may be incorporated into the HUD 110. Referring to FIGS. 9 and 10, in an embodiment, a HUD 900 is shown that may comprise four sections (two central sections 910 and 920 and two side sections (right side 915 and left side 925). The HUD 900 displays an augmented reality format which integrates AD based information displayed simultaneously in cooperation with the real world landscape visible through the windshield. For example, virtual portions of vehicle 940 are displayed in sections 910 and 920 of HUD 900 while a real-life visible portion of the vehicle is visible between sections 910 and 920 through the windshield. In some embodiments, the HUD 900 may include an overlay on a flat transparent surface inside passenger compartment. The AD based information may be transparent or semi-transparent so that the roadway may be visible through the HUD 900. In some embodiments, the digital map 800 may be for example, a faint overlay and a GPS navigator path 950 may be displayed in the HUD 900 so that the driver can chose the road or lane that is the best way along the route instead of the driver looking at another screen. Some embodiments may project information visible within the driver's peripheral vision (for example, onto HUD side sections 915 and 925), which as will be appreciated, does not impede or distract from the driver's focus on the road ahead.

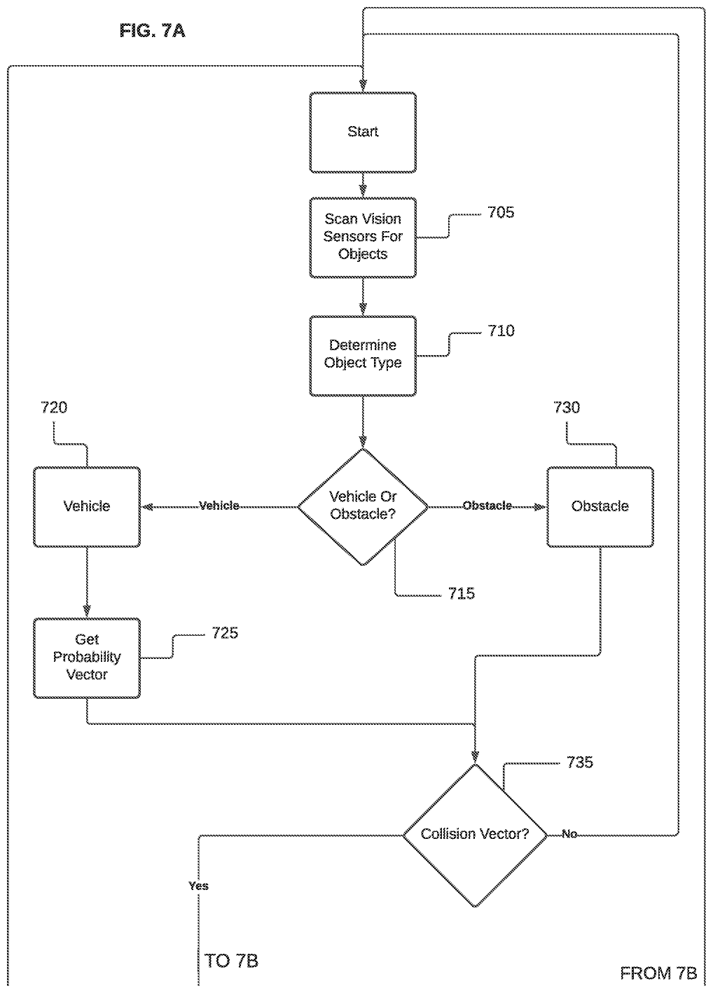

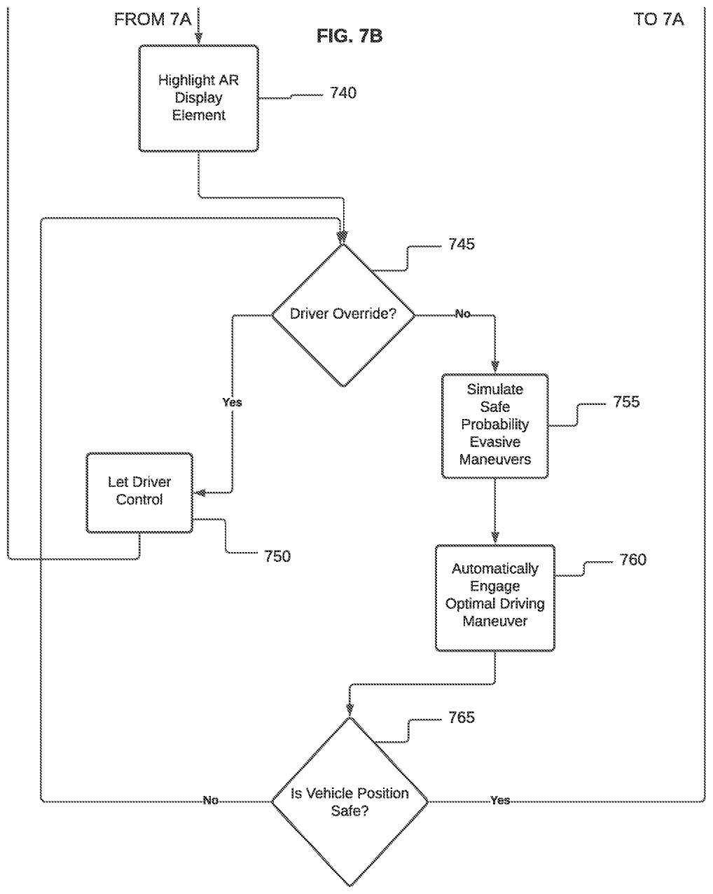

Referring now to FIGS. 7A and 7B, a process 700 for displaying autonomous driving information and recommendations on a head up display is shown according to embodiments. Sensors (for example, sensors 130) may scan 705 for real world objects in the environment surrounding the vehicle. The HUD controller 1440 may determine 710 a type of object detected for each object that registers a signal from the sensors. The collision detection engine 1444 may determine 715 whether a detected object based on its determined type, is another vehicle 720 or an obstacle 730. In the scenario where an obstacle 730 is detected, the collision detection engine 1444 determines 735 whether the subject vehicle's current course is on a collision vector with the obstacle 730. In the scenario where a vehicle 720 is detected, the collision detection engine 1444 may compute a probability vector of the subject vehicle's course intersecting the vehicle 720's course. The vector calculation may consider the subject vehicle's direction and speed compared to the vehicle 720's direction and speed and whether or not the two vehicles will meet at a point of intersection at the same time. The collision detection engine 1444 may determine 735 whether the subject vehicle's current course is on a collision vector with the vehicle 720. For imminent collisions, the HUD controller 1440 may illuminate or otherwise highlight 740 the vehicle 720 or obstacle 730 as the case may be. In some embodiments, the vehicle control system 1420 may be in default control of the vehicle. The autonomous driving control engine 1430 may determine 745 whether the driver has overridden autonomous control of the vehicle. In the event the driver has taken control, the vehicle may be manually driven until autonomous driving is re-engaged. In the event the driver has not taken control, the simulation engine 1445 may simulate 755 safe probability evasive maneuvers that are forwarded to the autonomous driving control engine 1430 via the CPU 1410. The autonomous driving control engine 1430 may select an optimal alternate course for the vehicle and automatically engages 760 in the optimal driving maneuver to avoid collision. The collision detection engine 1444 may check to see if the vehicle's deviated path is safe. If the latest position remains unsafe, the steps for checking driver override 745, and simulating evasive maneuvers 755 to 760 are repeated until the vehicle is travelling along a safe course.

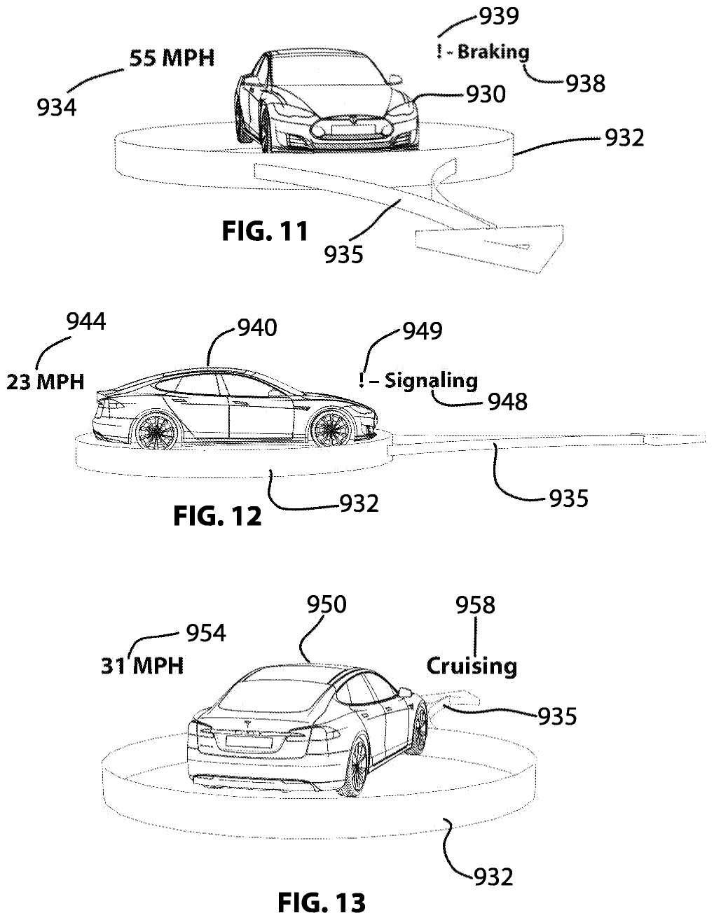

Referring now to FIGS. 10-13, examples of virtual objects displayed in the 900 (or HUD 110) are shown according to some embodiments. In some embodiments, other vehicles may be visible through the AR scene and augmented with virtual indicators or other graphical objects. Virtual objects and indicators may be generated for example by the virtual object/indicator engine 1447 (See FIG. 14). FIG. 10 shows for example, three vehicles, 930, 940, and 950 within the line of sight of the subject vehicle. The vehicle 930 is travelling in a direction that generally approaches the subject vehicle. FIG. 11 shows in enlarged detail that the HUD 900 may display a virtual ring 932 surrounding the vehicle 930 (so that it can be easily seen) and a directional graphic (virtual arrow 935) that points in the direction of vehicle 930's travel. A velocity graphic 934 may be displayed near the vehicle 930 to show its current speed. An action flag 938 may display a current type of action the vehicle 930 is taking. As shown, the vehicle 930 is indicated as braking as one would expect in a scenario where the subject vehicle is approaching an intersection. In some embodiments, a virtual alarm indicator 939 may be displayed proximate the action flag 938 to indicate a change of course or action that is occurring. Vehicle 940 is crossing in front of the subject vehicle. Its respective virtual ring 932 highlights the presence of the vehicle and its virtual arrow 935 shows that it is travelling straight across the face of the HUD 900 (perpendicular to the direction of the subject vehicle). The velocity graphic 944 shows that vehicle 940 is currently passing by at 23 mph but should be monitored because the virtual alarm indicator 949 is on and the action flag 948 shows that the vehicle 940 is signaling it is turning which may be towards the subject vehicle. The vehicle 950 is shown as travelling away from the subject vehicle and its velocity graphic 954 and action flag 958 show it is cruising at a speed of 31 mph with no apparent indication in a change of course. In some embodiments, the vehicles 930, 940, and 950 are real world vehicles while in other embodiments that generate a whole AR scene, the vehicles 930, 940, and 950 are virtual objects displayed over in in lieu of the real vehicles. As mentioned previously, the AR scene with virtual vehicles may be useful in low visibility conditions.

In some embodiments, the AR display may be delivered through a worn device and the system may transmit the AD information into the worn device. Some embodiments may incorporate voice control, speech to text and text to speech features whose input/output may be included on the HUD 110/900.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 1410, which executes and creates means for implementing the functions/acts specified in the flowchart and/or block diagram block or blocks in the figures. In some embodiments, this may be software or a software application, sometimes referred to colloquially as an “app”.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A vehicle driving assist system for a vehicle including a vehicle cabin, comprising:
a head-up display (HUD);
an augmented reality (AR) engine connected to the HUD;
one or more sensors positioned on the vehicle and disposed to detect an environment surrounding the vehicle;
a processor connected to the one or more sensors and to the AR engine, wherein:
environmental data detected by the one or more sensors is provided to the processor,
the processor is configured to determine a presence of physical objects and a position of respective physical objects relative to the vehicle based on the environmental data, and
the AR engine displays on the HUD an augmented reality scene, wherein the augmented reality scene includes one or more virtual objects associated with one of the physical objects.

2. The system of claim 1, wherein one of the one or more virtual objects is a virtual representation of one of the physical objects.

3. The system of claim 2, wherein the physical objects include automobiles.

4. The system of claim 1, wherein one of the one or more virtual objects is a status indicator of one of the physical objects, wherein the status indicator shows one of at least a current velocity of the physical object, a current action of the physical object, and a current direction of the physical object.

5. The system of claim 1, wherein the HUD is displayed on a windshield of the vehicle.

6. The system of claim 1, wherein the HUD is positioned in front of or on, one or more of a windshield of the vehicle, a driver side window, or a passenger side window.

7. The system of claim 1, further comprising a projector connected to the AR engine, wherein the projector projects the display of the augmented reality scene.

8. The system of claim 1, further comprising a layer of fluorinated ethylene propylene (FEP) in front of or on an interior side of a windshield, and wherein the display of the augmented reality scene is displayed on the layer of FEP.

9. The system of claim 1, wherein the AR engine is configured to simulate a virtual representation replicating the environment surrounding the vehicle and display the simulated virtual representation replicating the environment in the HUD.

10. The system of claim 1, further comprising a simulation engine connected to the processor, and configured to simulate driving scenarios in the environment based on the environmental data.

11. The system of claim 10, wherein the simulation engine is configured to predict a collision course with one or more of the physical objects.

12. The system of claim 11, wherein the simulation engine is configured to determine an alternate course for the vehicle in the event the vehicle is on the collision course with the one or more physical objects.

13. The system of claim 12, wherein the AR engine is configured to display the alternate course in the HUD.

14. The system of claim 12, wherein the processor is:
connected to a driving control system of the vehicle,
configured to take over control of the vehicle's driving control system based on the predicted collision course,
drive the vehicle onto the alternate course to avoid a predicted collision with the one or more physical objects.

15. The system of claim 1, further comprising a digital global positioning system map displayed in the HUD.

16. The system of claim 15, wherein the AR engine is configured to display a virtual route in the HUD.

17. The system of claim 1, further comprising a projector connected to the AR engine, wherein
the HUD includes three sections positioned in front of or on, a windshield of the vehicle, a driver side window, and a passenger side window,
the projector is configured to selectably project the display of the augmented reality scene onto one or more of the windshield, the driver side window, and the passenger side window.

18. The system of claim 1, wherein the sensors comprise at least one of cameras, forward looking infrared detectors, thermal detectors, or ultrasonic detectors.
